(19) United States
(12) Patent Application Publication
(10) Pub. No.: US 2015/0054276 A1
(43) Pub. Date: Feb. 26, 2015

(54) High-Pressure Bidirectional Seal

(71) Applicant: Taper-Lok Corporation, Houston, TX (US)

(72) Inventors: John L. Alsup, Houston, TX (US); Darin L. Clause, Bellaire, TX (US)

(73) Assignee: Taper-Lok Corporation, Houston, TX (US)

(21) Appl. No.: 13/971,952

(22) Filed: Aug. 21, 2013

(51) Int. Cl. F16L 23/18; F16L 23/02; F16J 15/06

(52) U.S. Cl. CPC F16L 23/18; F16J 15/068; F16L 23/02
USPC 285/368; 277/612

(57) ABSTRACT

A high-pressure connection in a conduit or enclosure utilizing a bidirectional, pressure-energized seal. Male and female flanges are provided, where one of the flanges has a recess that accommodates a seal ring. The outer peripheries of the two flanges' sealing surfaces are in contact with each so that clamping, bolting and bending stresses are not borne by the seal ring. The seal ring has a cross-section that includes a solid body and two V shaped sealing portions that extend from the body at an angle between 90 and 160 degrees. Each sealing portion has a set of opposing sealing faces with a cavity between them, so that fluid pressure within the cavity urges the sealing faces outward from the first cavity toward the flanges.

### BACKGROUND

1. Field of the Invention

The invention relates generally to seals in high pressure connections, and more particularly to systems and methods for making bidirectional, pressure-energized seals in high-pressure pipe systems.

2. Related Art

While there are a variety of systems and techniques for sealing connections between components of high-pressure pipe systems (e.g., flange couplings or closures) that may be used in oil production, chemical processing, etc.

The use of pipelines or other conduits to carry pressurized fluids is widely known. For instance, such pipelines may be used to transport natural gas or other fluid hydrocarbons. Still other pipelines may be used to transport corrosive, toxic or otherwise dangerous fluids. These systems typically consist of multiple components (e.g., tubulars, end closures, valve bonnets, etc.) that are connected to for a sealed conduit or enclosure. Seals of some type are commonly used to prevent leakage at the connections.

Typically, these pipelines are internally pressurized, and the seals are designed to prevent from leaking out of the conduits. Others are externally pressurized. In some cases, it is desirable to have seals that are bidirectional. In other words, they prevent fluids from escaping from the conduit, and also prevent fluids from entering the conduit. Embodiments of the invention disclosed herein are designed to prevent leakage bi-directionally, and to be energized by fluid pressure differences to which the connection is exposed

### SUMMARY OF THE INVENTION

One or more of the problems outlined above may be solved by the various embodiments of the invention. Broadly speaking, the invention comprises systems and methods for sealing coupling flanges, tubular, end closures, valve bonnets, or other components of a conduit or enclosure.

One particular embodiment comprises a bidirectional pressure-energized seal ring. The seal ring is generally annular, and has a cross-section which includes a body portion and two sealing portions that extend from the body. Each of the sealing portions is generally V-shaped, having a set of opposing sealing faces with a cavity between them. Fluid pressure within the cavity urges the sealing faces outward from the cavity, toward the faces of the flanges between which the seal ring is installed. The two sealing portions do not face opposite directions, but are instead angled. The sealing portions face directions that are between 90 and 160 (and preferably about 100) degrees apart. Because the sealing portions are angled, the body portion forms a load shoulder which abuts an interior corner of a recess between the flanges of a connection and thereby prevents the fluid pressure from moving the seal ring within the recess. The body portion of the seal ring is solid, and consequently provides resistance to shearing forces between the flanges.

An alternative embodiment comprises a high-pressure connection in a conduit, where the connection includes a bidirectional, pressure-energized seal. In this embodiment, a first flange has a sealing surface that includes a female pocket. A second flange has a sealing surface that includes a male nose. The male nose of the second flange is configured to mate with the female pocket of the first flange. A recess is formed in at least one of the flanges, and a seal ring is seated in the recess to form a seal between the two flanges. The outer peripheries of the two flanges' sealing surfaces are in contact with each other in the assembled connection so that the bending moments imparted by loads on the conduit being sealed and the associated stresses are borne by the flanges, and not to the seal ring. The seal ring is a bidirectional, pressure-energized device. The cross-section of the seal ring includes a solid body and two V shaped sealing portions that extend from the body at an angle between 90 and 160 degrees. Each sealing portion has a set of opposing sealing faces with a cavity between them, so that fluid pressure within the cavity urges the sealing faces outward from the first cavity toward the flanges.

Numerous other embodiments are also possible.

### BRIEF DESCRIPTION OF THE DRAWINGS

Other objects and advantages of the invention may become apparent upon reading the following detailed description and upon reference to the accompanying drawings.

FIG. 1 is a diagram illustrating a cross-sectional view of an assembled high-pressure connection in accordance with one embodiment.

FIG. 2 is a diagram illustrating a cross-sectional view of some of the components of the connection of FIG. 1.

FIG. 3 is a diagram illustrating a cross-sectional view of a seal ring in accordance with one embodiment.

FIG. 4 is a diagram illustrating a cross-sectional view of a seal ring in accordance with an alternative embodiment.

FIG. 5 is a diagram illustrating a cross-sectional view of a seal ring in accordance with another alternative embodiment.

FIGS. 6A-6E are diagrams illustrating alternative embodiments of an anti-rotation protrusion.

FIG. 7 is a diagram illustrating a perspective view of a portion of a seal ring in accordance with one embodiment.

While the invention is subject to various modifications and alternative forms, specific embodiments thereof are shown by way of example in the drawings and the accompanying detailed description. It should be understood, however, that the drawings and detailed description are not intended to limit the invention to the particular embodiment which is described. This disclosure is instead intended to cover all modifications, equivalents and alternatives falling within the scope of the present invention as defined by the appended claims.

### DETAILED DESCRIPTION OF PREFERRED EMBODIMENTS

One or more embodiments of the invention are described below. It should be noted that these and any other embodiments described below are exemplary and are intended to be illustrative of the invention rather than limiting.

As described herein, various embodiments of the invention comprise systems and methods for making connections in high-pressure conduits, where the connections incorporate bidirectional pressure-energized seals. In an exemplary embodiment, a connection utilize a seal ring that has cavities between opposing sealing surfaces to enable fluid pressure to urge the sealing surfaces toward the respective flanges of the connection. The portion of the seal ring that is energized by external fluid pressure is angled with respect to the portion that is energized by internal fluid pressure. The angle provides a load shoulder in each direction which prevents the fluid pressure from moving the seal ring. A central body of the seal ring is solid to provide shear resistance. Recesses may be provided in the sealing surfaces of the seal ring in order to multiply the contact pressure between the sealing surfaces of the seal ring and the flanges of the connection. The flanges may include recesses to relieve stresses that induce rotation of the seal ring as the connection is assembled.

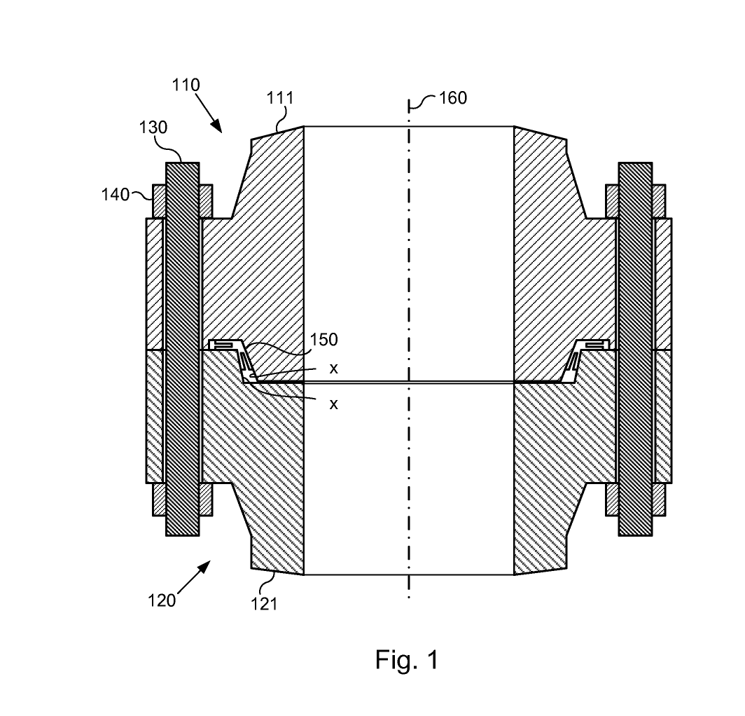

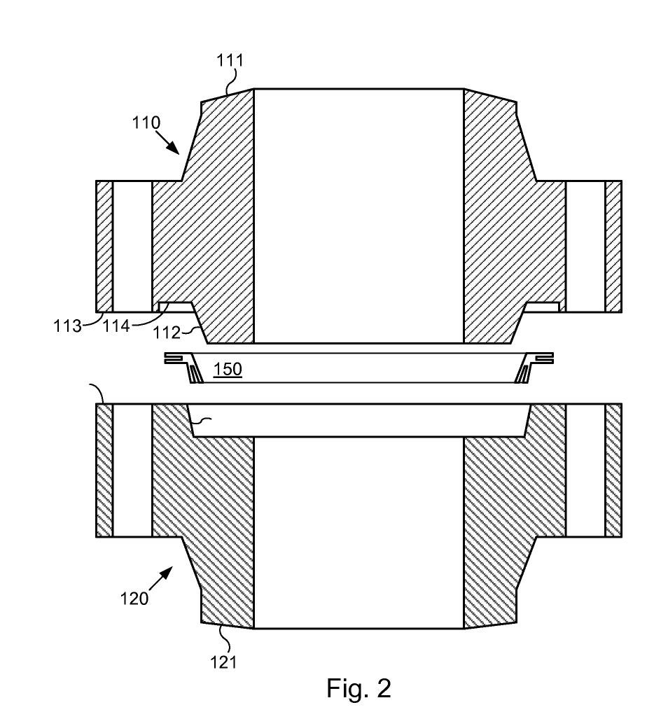

Referring to FIGS. 1 and 2, a pair of cross-sectional views of a pipe connection in accordance with one embodiment is shown. FIG. 1 is a view of the connection in an assembled state, while FIG. 2 is a view of the connection in a partially disassembled state.

Referring to FIG. 1, connection 100 includes a first (male) flange 110 and a second (female) flange. Each of flanges 110 and 120 in this embodiment has a beveled edge (111 and 121, respectively) that is designed to be welded to a corresponding pipe section. Each of flanges 110 and 120 has a sealing surface that is designed to contact that of the other flange, or seal ring 150, thereby providing a seal between the flanges. Flanges 110 and 120 are secured to each other by means of bolts (e.g., 130) and nuts (e.g., 140) or other fastening mechanisms.

Flange 110 has a male nose 112. Male nose 112 is an outwardly-facing conic section that appears as a tapered surface in the figures. Male nose 112 is configured to fit within female pocket 122 of flange 120 as shown in FIG. 2. Female pocket 122 is an inwardly-facing conic section that appears as a tapered surface FIGS. 1 and 2. The taper of female pocket 122 is nearly complementary to the taper of male mating surface 113, but a tapered gap is formed by the surface of the female pocket and the male nose when the two flanges are coupled together.

Flange 110 also has a recess 114 in which seal ring 150 is seated in the assembled connection. The outer peripheries (113, 123) of the flanges' contact surfaces contact each other in the assembled connection. In other words, the flanges bottom out against each other, while leaving space in recess 114 for seal ring 150. This allows the connection to withstand greater bending stresses without placing unnecessary and possibly damaging stresses on seal ring 150.

Seal ring 150 provides a bidirectional, pressure-energized seal. In other words, seal ring 150 is designed to be energized by fluid pressure, either from the interior of the connection, or from the exterior of the connection. This is achieved by providing V-shaped portions that have cavities which are exposed to fluid paths from the interior and exterior of the connection, respectively. The fluid pressure in the cavity urges the legs of the V-shape outward, toward the sealing surfaces of the flanges (i.e., the fluid pressure energizes the seal). Because seal ring 150 is seated in a corner of the gap between flanges 110 and 120, the fluid pressure in either cavity does not cause the seal ring to move.

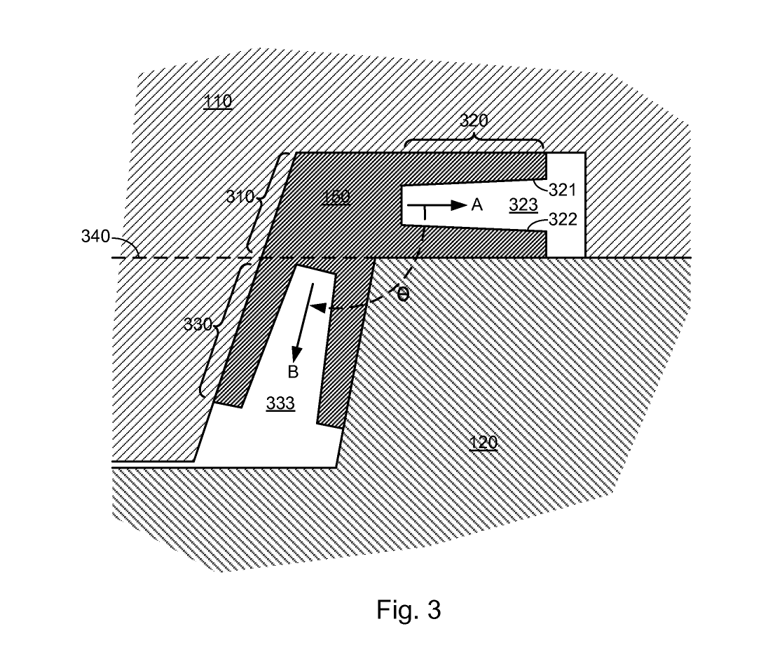

Referring to FIG. 3, the portion of the connection around the seal ring is shown in more detail. It should be noted that the description of the seal ring herein will refer primarily to the features that appear in the cross-sectional view of the seal ring. It will be understood by persons of ordinary skill in the art that the seal ring is axially symmetric (i.e., symmetric about the axis 160).

Central portion 310, and two sealing portions 320 and 330. These three portions of the seal ring are integral, and are separately identified only to facilitate the description of the seal ring. The first sealing portion 320 extends radially outward from the axis of the ring (facing the outer periphery of the connection) in a first direction, A. The second sealing portion 330 faces downward and slightly inward toward the seal ring's axis in a second direction, B. The angle (θ) between directions A and B is approximately 100 degrees in this embodiment, but this may vary in other embodiments from approximately 90 degrees to approximately 160 degrees.

Each of the sealing portions (320, 330) is roughly V-shaped (or U-shaped), having a pair of legs (e.g., 321, 322) with a cavity (e.g., 323) between them. An outer face of each leg has a sealing surface that contacts the face of a corresponding one of the flanges. For example, the outer (upper) face of leg 321 contacts male flange 110 and forms a seal against this flange, while the outer (lower) face of leg 322 contacts female flange 120 and forms a seal against it. When fluid pressure is applied to the interior of the cavity (e.g., 323), the pressure urges the legs outward from the cavity toward the respective ones of flanges 110 and 120. The fluid pressure thereby energizes the seal and increases the contact pressure between the seal ring and the flanges over the loading applied when the connection is assembled. The seal ring is bidirectional—the first sealing portion (320) is energized when the fluid pressure exterior to the connection is greater than the fluid pressure interior to the connection, and the second sealing portion (330) is energized when the fluid pressure interior to the connection is greater than the fluid pressure exterior to the connection.

As noted above, sealing portions 320 and 330 are angled with respect to each other. As a result, central portion 310 forms a load shoulder which abuts flange 110 in the corner of recess 114. The load shoulder prevents the seal ring from moving away from the pressure. For example, when fluid pressure is applied to cavity 323, in addition to urging legs 321 and 322 toward flanges 110 and 120, respectively, it will urge the seal ring in the direction opposite direction A. Because central portion 310 is butted against flange 110, however, the seal ring will not move away from direction A. Similarly, when fluid pressure is applied to cavity 333, it will urge the seal ring in the direction opposite direction B, but since central portion 310 is butted against flange 110, the seal ring will not move away from direction B.

Another feature of seal ring 150 is that central portion 310 provides some shear resistance to the seal ring. As shown in FIG. 3, central portion 310 is solid. This includes a volume that is within the projection of sealing portion 320 radially inward (i.e., in the direction opposite direction A). The solid volume of central portion 310 extends a bit beyond this projection so that it is solid along the plane (340) at which the outer periphery 113 of flange 110 contacts the outer periphery 123 of flange 120. Since central portion 310 is solid along this plane, it resists shearing of seal ring 150 that might arise from lateral movement (left and right in the figure) of the flanges with respect to each other.

In the embodiment of FIGS. 1-3, the sealing faces of sealing portion 320 are parallel. The sealing faces of sealing portion 330 are not parallel, but are instead slightly tapered with respect to each other. It should be noted that the respective angles of the sealing faces of the sealing portions may be different in other embodiments.

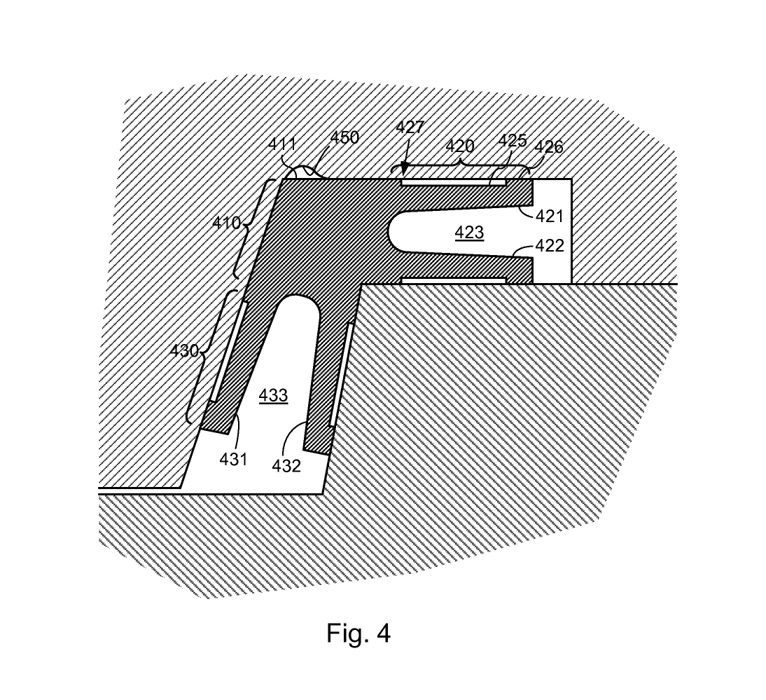

Referring to FIG. 4, an alternative embodiment of the seal ring is shown. In this embodiment, seal ring 400 has an overall shape which is similar to that of seal ring 150, with a solid central portion 410, and two sealing portions 420, 430. sealing portion 420 extends radially outward from central portion 410, while sealing portion 430 extends downward and slightly inward. Cavities 423 and 433 within the respective sealing portions enable fluid pressure to urge the sealing faces of the sealing portions to be urged toward the corresponding sealing faces of the flanges. The angle between the sealing portions provides a load shoulder that abuts the corner of the recess in the male flange to prevent movement of the seal within the recess

The primary difference between seal ring 400 and seal ring 150 is that each of the sealing faces in seal ring 400 has a recess. For example, leg 421 has a recess 425 in its sealing face. Recess 425 is positioned between central portion 410 and the end of sealing portion 420. Recess 425 extends along most of the length of sealing portion 420, but a small portion of the sealing face (426) remains raised so that it contacts the sealing surface of the male flange. Leg 421 pivots to some degree at point 427 at the end of recess 415 nearest central portion 410.

As a result of these recesses, the fluid pressure in cavity 423 that is applied to leg 421 generates increased contact pressure at area 426 at the end of leg 421, rather than along the entire length of leg 421. This multiplies the contact pressure between seal ring 400 (at area 426) and the male flange in comparison to seal ring 150. As shown in the figure, each of the legs (421, 422, 431, 432) of the seal has a corresponding seal face recess that serves as a multiplier of the contact pressure between the seal ring and the corresponding sealing faces of the flanges. In other embodiments, the recesses could be used on any combination of the legs.

It should be noted that, in a preferred embodiment, when seal ring 400 is unstressed (e.g., uninstalled) the contact surface (426) at the end of the leg (421) lies in substantially the same plane as the upper edge 411 of body 410. If contact surface initially lies above this plane, installation of the seal ring in the connection causes the leg to flex inward, toward the cavity. Although this results in some space between the leg and the surface of the flange, the flexed leg does not provide a substantially stationary pivot point (e.g., 427) for the leg and consequently is not as effective as a multiplier of the fluid pressure in the cavity.

In one embodiment, the male flange has a relief recess 450 at the base of the nose. The recess is formed in the portion of the flange surface that is generally perpendicular to the axis of the flange. The recess in this embodiment is rounded and follows a spline curve that reduces stresses in the flange. Recess 450 allows the connection to be assembled without causing twisting of the seal ring between the male nose and the female pocket.

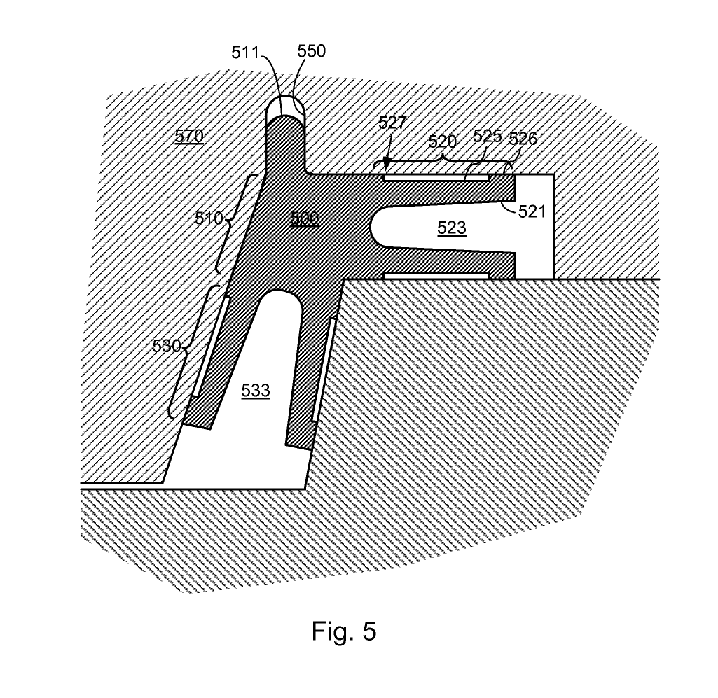

Referring to FIG. 5, another alternative embodiment of the seal ring is shown. In this embodiment, the structure of seal ring is very similar to the embodiment of FIG. 4, in that seal ring 500 has a solid central portion 510, and two sealing portions 520, 530 that extend radially outward and downward, respectively. Cavities 523 and 533 are formed within the respective sealing portions to enable fluid pressure to urge their sealing faces to be urged toward the corresponding sealing faces of the flanges. Each of the sealing faces of seal ring 500 has a recess (e.g., 525) which effectively forms a pivot point (e.g., 527) and allows the fluid pressure on the corresponding leg (e.g., 521) within the cavity (e.g., 523) to be concentrated on the raised portion (e.g., 526) of the sealing face.

The embodiment of FIG. 5 differs from that of FIG. 4 in that a larger recess 550 is formed in the male flange 570. Recess 550 is formed at the base of the nose of the male flange and is elongated in comparison with recess 450. Seal ring 500 includes a protrusion 511 that extends into recess 550 when the seal ring is seated against the male flange. The positioning of protrusion 511 within recess 550 prevents the body of the seal ring from rotating when the connection is assembled (and may therefore be referred to as an anti-rotation protrusion). It should be noted that, in an alternative embodiment, the protrusion may extend from the flange into a recess in the body of the seal ring.

In one embodiment, protrusion 511 and recess 550 may be configured to allow the protrusion to slide easily into and out of the recess. In another embodiment, the sizes and shapes of protrusion 511 and recess 550 may be designed to provide an interference fit of the protrusion into the recess. In this case, the interference between these features would tend to hold protrusion 511 in recess 550, thereby holding seal ring 500 in position against flange 570. This configuration could be advantageous, particularly in subsea environments, because it may prevent mis-positioning of the seal ring as the connection is assembled, as well as possible loss of the seal ring when the connection is disassembled. Protrusion 511 and recess 550 may also include features that interlock with each other, allowing the protrusion to snap into place within the recess. This would more securely hold the seal ring in position against the flange. The specific configuration of the interlocking features can be designed to provide the desired retention strength.

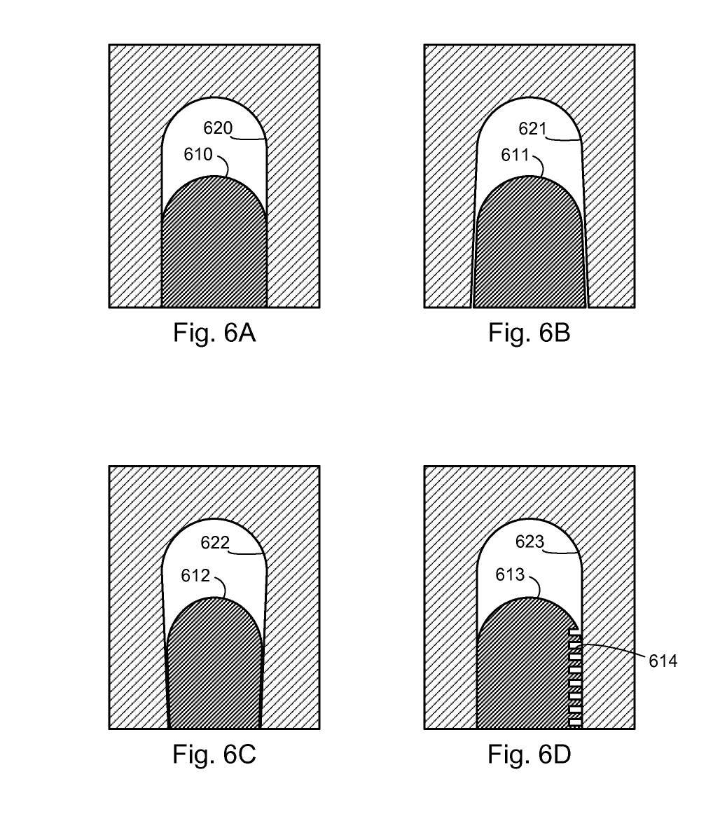

Referring to FIGS. 6A-6E, several possible relative configurations of the protrusion and recess are illustrated. FIG. 6A is a diagram illustrating an interference fit between protrusion 610 and recess 620 which will retain the seal ring on the male flange. FIG. 6B is a diagram illustrating a configuration in which there is no interference between protrusion 611 and recess 621, so the protrusion will fit within the recess and will prevent rotation of the seal ring, but will not retain the seal ring on the flange. FIG. 6C is a diagram illustrating a configuration in which protrusion 612 and recess 622 are both tapered so that they are wider at the top. Consequently, after protrusion 612 is pushed into recess 622, the tapers of the features interfere and resist removal of the protrusion from the recess. FIG. 6D is a diagram illustrating a configuration in which protrusion 613 is sized to provide an interference fit within recess 623. In this embodiment, protrusion 613 has several grooves cut into its outer diameter to form teeth (e.g., 614). These teeth can flex somewhat to allow protrusion 613 to be more easily pushed into or removed from recess 623 while still providing an interference fit. FIG. 6E is a diagram illustrating a configuration in which protrusion 615 is configured to interlock with recess 625. In this embodiment, the end of protrusion 615 curves radially outward (to the right in the figure). Recess 625 has an inward-facing bump 626. When protrusion 615 is inserted into recess 625, the curved end portion of protrusion 615 interlocks with bump 626 to retain the protrusion within the recess unless a user forces the protrusion past the bump to remove the seal ring from the flange.

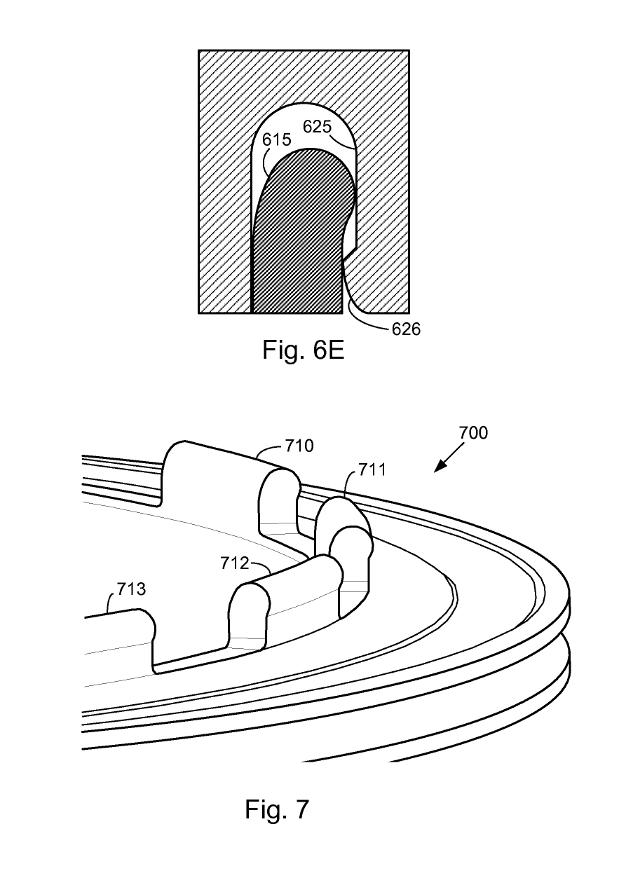

Referring to FIG. 7, a diagram illustrating a perspective view of a portion of a seal ring in accordance with one embodiment is shown. In this embodiment, seal ring 700 has a set of separate, segmented portions (710-713) that have a profile as shown in FIG. 6E. By segmenting the protrusion, each individual portion can have a thicker section (the radial thickness of the protrusion), while remaining flexible enough to allow the seal ring to be installed or removed without requiring excessive force.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. For instance, although the embodiments described above relate to the connection of two pipe-end flanges, alternative embodiments may be used to couple together other components, such as enclosures, conduits, housings, closures, valve, etc. It is contemplated that these variations, modifications, additions and improvements fall within the scope of the invention as detailed within the following claims.

What is claimed is:

1. A device comprising:
a bidirectional pressure-energized seal ring having a cross-section which has
a body,
a first sealing portion adjacent to the body, including a first set of opposing sealing faces having a first cavity therebetween, wherein fluid pressure within the first cavity urges the first set of sealing faces outward from the first cavity, and
a second sealing portion adjacent to the body, including a second set of opposing sealing faces having a second cavity therebetween, wherein fluid pressure within the second cavity urges the second set of sealing faces outward from the second cavity,
wherein the first cavity opens away from the body toward a first direction, and the second cavity opens away from the body toward a second direction which forms an angle of between 90 degrees and 160 degrees with the first direction.

2. The device of claim 1, wherein the body provides a first load shoulder which prevents pressure in the first cavity from causing the seal ring to move away from the first direction.

3. The device of claim 2, wherein the body provides a second load shoulder which prevents pressure in the second cavity from causing the seal ring to move away from the second direction.

4. The device of claim 1, wherein a portion of the body is solid, the solid portion including an volume that falls within a projection of the first sealing portion in a direction opposite the first direction.

5. The device of claim 1, wherein for at least one of the first and second sets of sealing faces, each of the sealing faces includes a sealing face recess between the body and an end of the sealing face opposite the body.

6. The device of claim 1, wherein the first direction is radially outward from an axis of the seal ring.

7. The device of claim 1, further comprising an anti-rotation protrusion extending outward from the body of the seal ring

8. The device of claim 7, wherein the anti-rotation protrusion is segmented into a plurality of individual portions that are configured to interlock with a complementary recess in a flange.

9. A high-pressure connection having a bidirectional pressure-energized seal, the connection comprising:
a first flange having a first sealing surface that includes a female pocket;
a second flange having a second sealing surface that includes a male nose,
wherein the male nose is configured to mate with the female pocket,
wherein at least one of the first and second sealing surfaces has a seal ring recess therein when an outer periphery of the first sealing surface is in contact with an outer periphery of the second sealing surface; and
a bidirectional pressure-energized seal ring
wherein the seal ring has a cross-section which has
a body,
a first sealing portion adjacent to the body, including a first set of opposing sealing faces having a first cavity therebetween, wherein fluid pressure within the first cavity urges the first set of sealing faces outward from the first cavity, and
a second sealing portion adjacent to the body, including a second set of opposing sealing faces having a second cavity therebetween, wherein fluid pressure within the second cavity urges the second set of sealing faces outward from the second cavity,
wherein the first cavity opens away from the body toward a first direction, and the second cavity opens away from the body toward a second direction which forms an angle of between 90 degrees and 160 degrees with the first direction.

10. The high-pressure connection of claim 9, wherein a portion of the body that lies in a plane of contact between the outer periphery of the first sealing surface and the outer periphery of the second sealing surface is solid.

11. The high-pressure connection of claim 9, wherein the body provides a first load shoulder which prevents pressure in the first cavity from causing the seal ring to move away from the first direction.

12. The high-pressure connection of claim 11, wherein the body provides a second load shoulder which prevents pressure in the second cavity from causing the seal ring to move away from the second direction.

13. The high-pressure connection of claim 9, wherein a portion of the body is solid, the solid portion including an volume that falls within a projection of the first sealing portion in a direction opposite the first direction.

14. The high-pressure connection of claim 9, wherein for at least one of the first and second sets of sealing faces, each of the sealing faces includes a sealing face recess between the body and an end of the sealing face opposite the body.

15. The high-pressure connection of claim 9, wherein the first direction is radially outward from an axis of the seal ring.

16. The high-pressure connection of claim 9, wherein the second sealing surface has a relief recess at a base of the male nose, wherein the relief recess prevents the seal ring from twisting between the male nose and the female pocket.

17. The high-pressure connection of claim 9, wherein the second sealing surface has a recess at a base of the male nose, wherein the seal ring has a protrusion that extends from the body, and wherein the protrusion fits within the recess as the seal ring is seated against the second flange and thereby prevents rotation of the seal ring with respect to the second flange.

18. The high-pressure connection of claim 17, wherein the protrusion is configured to provide an interference fit with the recess, thereby retaining the seated seal ring on the second flange.

19. The high-pressure connection of claim 18, wherein the protrusion is segmented into a plurality of separate portions.
